(19) United States
(12) Patent Application Publication
(10) Pub. No.: US 2014/0267111 A1
(43) Pub. Date: Sep. 18, 2014

(54) METHOD FOR HANDLING FUNCTION CORRESPONDING TO MULTIPLE TOUCHES AND ELECTRONIC DEVICE THEREOF

(71) Applicant: Samsung Electronics Co., Ltd., Gyeonggi-do (KR)

(72) Inventor: Tae-Gun Park, Gyeonggi-do (KR)

(73) Assignee: Samsung Electronics Co., Ltd., Gyeonggi-do (KR)

(21) Appl. No.: 14/210,049

(22) Filed: Mar. 13, 2014

(30) Foreign Application Priority Data
Mar. 13, 2013 (KR) 10-2013-0026864

(51) Int. Cl. G06F 3/0488

(52) U.S. Cl. CPC G06F 3/04886
USPC 345/173

(57) ABSTRACT

A method includes sensing multiple touches for the displayed data, determining data to be displayed among the pieces of data constituting the at least one list on the basis of the number of touch points and a direction of moving the sensed multiple touches, and displaying data by switching from the selected data to the determined data. An electronic device includes a program configured to be executed by a processor, wherein the program includes instructions for displaying data selected from a plurality of pieces of data constituting at least one list, for sensing multiple touches for the displayed data, for determining data to be displayed among the pieces of data constituting the at least one list on the basis of a number of touch points and a direction of movement of the sensed multiple touches, and for displaying data by switching from the selected data to the determined data.

### PRIORITY

The present application is related to and claims the benefit under 35 U.S.C. §119(a) of a Korean patent application No. 10-2013-0026864 filed in the Korean Intellectual Property Office on Mar. 13, 2013 and assigned Serial No., the entire disclosure of which is hereby incorporated by reference.

### TECHNICAL FIELD

The present disclosure relates to an electronic device. More particularly, the present disclosure relates to a method for performing a function in an electronic device, and the electronic device for the method.

### BACKGROUND

In general, a variety of electronic devices employ input elements for data inputs and output elements for data outputs. A representative example of the input element includes a keypad, and a representative example of the output element includes a Liquid Crystal Display (LCD) element. If the input element and the output element are separately employed in the electronic device, the electronic device is inevitably increased in volume due to sizes and the numbers of the input elements and the output elements.

Accordingly, a touch screen capable of simultaneously performing input and output operations while decreasing the volume of the electronic device is launched. In particular, a recently launched electronic device has a complex touch screen and thus may sense multiple touches in which two or more touches are simultaneously generated. A user of the electronic device can more conveniently control the electronic device by using a multi-touch function provided in the electronic device. For example, by using the multi-touch function provided in the electronic device, the user of the electronic device can increase or decrease an image stored in the electronic device.

However, with the growing capacity of the electronic device and with the diversification of the function of the electronic device, it is inconvenient to control a plurality of pieces of data or to control various functions when using only a touch mechanism provided in the electronic device. For example, if it is intended to search for a specific image in a state where a gallery application is executed to display the image, the user of the electronic device has to repetitively touch a screen of the electronic device to thumb through images one by one until the image to be found is displayed. In this case, if a plurality of images are present between a currently displayed image and the specific image to be found, the user of the electronic device has to inconveniently perform a process of thumbing through the images multiple times.

Accordingly, it is necessary to provide a method capable of conveniently controlling a plurality of pieces of data provided in an electronic device.

### SUMMARY

To address the above-discussed deficiencies, it is a primary object to provide a method and apparatus for handling a function corresponding to multiple touches in an electronic device.

Another aspect of the present disclosure is to provide a method and apparatus for controlling a display of a list by using multiple touches in an electronic device.

Another aspect of the present disclosure is to provide a method and apparatus for controlling a display of a list according to the number of sensed multiple touches in an electronic device.

Another aspect of the present disclosure is to provide a method and apparatus for controlling a display of a list according to a distance between sensed multiple touches in an electronic device.

In accordance with an aspect of the present disclosure, a method of controlling an electronic device is provided. The method includes displaying data selected from a plurality of pieces of data constituting at least one list, sensing multiple touches for the displayed data, determining data to be displayed among the pieces of data constituting the at least one list on the basis of the number of touch points and a direction of moving the sensed multiple touches, and displaying data by switching from the selected data to the determined data.

In accordance with another aspect of the present disclosure, an electronic device is provided. The electronic device includes one or more processors, a touch sensitive display, a memory, and one or more programs stored in the memory and configured to be executed by the one or more processors, wherein the program includes an instruction for displaying data selected from a plurality of pieces of data constituting at least one list, for sensing multiple touches for the displayed data, for determining data to be displayed among the pieces of data constituting the at least one list on the basis of the number of touch points and a direction of moving the sensed multiple touches, and for displaying data by switching from the selected data to the determined data.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a high-level block diagram illustrating an electronic device for handling a function corresponding to multiple touches according to an exemplary embodiment of the present disclosure;

FIG. 1B is a high-level block diagram illustrating a structure of a processor for handling a function corresponding to multiple touches according to an exemplary embodiment of the present disclosure;

FIG. 2A illustrates a process of handling a function corresponding to the number of touch points of multiple touches in an electronic device according to an exemplary embodiment of the present disclosure;

FIG. 2B illustrates a means for handling a function corresponding to the number of touch points of multiple touches in an electronic device according to an exemplary embodiment of the present disclosure;

FIG. 3 illustrates a process of handling a function corresponding to a direction of moving multiple touches and the number of touch points in an electronic device according to an exemplary embodiment of the present disclosure;

FIGS. 4A to 4D illustrate an example of handling a function corresponding to a direction of moving multiple touches and the number of touch points when image data is displayed in an electronic device according to an exemplary embodiment of the present disclosure;

FIGS. 5A to 5D illustrate an example of handling a function corresponding to a direction of moving multiple touches and the number of touch points when music data is displayed in an electronic device according to an exemplary embodiment of the present disclosure;

FIGS. 6A to 6D illustrate an example of handling a function corresponding to a direction of moving multiple touches and the number of touch points when book data is displayed in an electronic device according to an exemplary embodiment of the present disclosure;

FIG. 7 illustrates a process of handling a function corresponding to a direction of moving multiple touches and a distance between touch points in an electronic device according to another exemplary embodiment of the present disclosure;

FIGS. 8A to 8D illustrate an example of handling a function corresponding to a direction of moving multiple touches and a distance between touch points when image data is displayed in an electronic device according to another exemplary embodiment of the present disclosure;

FIGS. 9A to 9D illustrate an example of handling a function corresponding to a direction of moving multiple touches and a distance between touch points when music data is displayed in an electronic device according to another exemplary embodiment of the present disclosure; and

FIGS. 10A to 10D illustrate an example of handling a function corresponding to a direction of moving multiple touches and a distance between touch points when book data is displayed in an electronic device according to another exemplary embodiment of the present disclosure.

### DETAILED DESCRIPTION

FIGS. 1A through 10D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Exemplary embodiments of the present disclosure will be described herein below with reference to the accompanying drawings. In the following description, well-known functions or constructions are not described in detail since they would obscure the disclosure in unnecessary detail. Also, the terms used herein are defined according to the functions of the present disclosure. Thus, the terms may vary depending on user's or operator's intension and usage. That is, the terms used herein must be understood based on the descriptions made herein.

An electronic device described hereinafter is a mobile communication terminal supporting a touch input, a smart phone, a tablet Personal Computer (PC), a digital camera, an Motion Picture Experts Group Layer 3 (MP3) player, a navigator, a laptop, a net-book, a computer, a television set, a refrigerator, an air conditioner, etc. In this case, the electronic device may have a display element and may be a multi-touch sensitive electronic device.

FIG. 1A is a block diagram illustrating an electronic device for handling a function corresponding to multiple touches according to an exemplary embodiment of the present disclosure.

Referring to FIG. 1A, an electronic device 100 includes a memory 110, a processor 120, and a touch screen 130. The memory 110 and the processor 120 can be plural in number.

The memory 110 includes a data storage unit 111, an operating system program 112, an application program 113, a graphic user interface program 114, a multi-touch sensitive program 115, a list control program 116, etc. In addition, since a program which is a software component can be expressed in a group of instructions, the program is also expressed in an instruction set. The program is also expressed in a module.

The memory 110 can store one or more programs including instructions for executing the exemplary embodiment of the present disclosure.

The data storage unit 111 stores data generated while performing a function corresponding to the program stored in the memory 110. The data storage unit 111 of the present disclosure can store data by mapping a touch moving direction and a search direction of displayed data. In other words, if a touch sensed for currently displayed data moves in a specific direction, the data storage unit 111 can map and store whether to display data by searching for previous or next data with respect to the currently displayed data. For example, if the touch sensed for the displayed data moves from right to left, the data storage unit 111 can store information indicating that the next data with respect to the currently displayed data is found and displayed. For another example, if the touch sensed for the displayed data moves from left to right, the data storage unit 111 can store information indicating that the previous data with respect to the currently displayed data is found and displayed. For another example, if the touch sensed for the displayed data moves from down to up, the data storage unit 111 can store information indicating that the previous data with respect to the currently displayed data is found and displayed. For another example, if the touch sensed for the displayed data moves from up to down, the data storage unit 111 can store information indicating that the previous data with respect to the currently displayed data is found and displayed. Herein, the next data can imply data located to the right of current data in a list including the currently displayed data, or can imply data located below thereof. In addition, the previous data can imply data located to the left of current data in a list including the currently displayed data, or can imply data located above thereof.

In addition, the data storage unit 111 can store data by mapping the number of touch points and the number of pieces of data to be skipped. For example, if a touch moves in a specific direction in a state where the number of touch points sensed for the displayed data is 2, the data storage 111 can store that the number of pieces of data to be skipped is 10. For another example, if a touch moves in a specific direction in a state where the number of touch points sensed for the displayed data is 3, the data storage 111 can store that the number of pieces of data to be skipped is 20. Herein, the skip implies that at least one piece of data is skipped to access next data, instead of sequentially accessing data according to a data sorting order. That is, the data to be skipped implies data which is skipped to access next data in a data access process.

In addition, the data storage unit 111 can store data by mapping a distance between two touch points and the number of pieces of data to be skipped. For example, if a touch moves in a specific direction in a state where a distance between two touch points sensed for the displayed data is greater than or equal to a first threshold distance and less than or equal to a second threshold distance, the data storage unit 111 can store that the number of pieces of data to be skipped is 10. For another example, if a touch moves in a specific direction in a state where a distance between two touch points sensed for the displayed data is greater than or equal to the second threshold distance and less than or equal to a third threshold distance, the data storage unit 111 can store that the number of pieces of data to be skipped is 20. According to another exemplary embodiment, the data storage unit 111 can store a predetermined equation for calculating the number of pieces of data to be skipped on the basis of a distance between two touch points.

In addition, the data storage unit 111 can store a to-be-skipped object according the number of touch points or a distance between touch points. For example, if the number of sensed touch points is 2 in image data, the data storage unit 111 can store that the to-be-skipped object is an image. For another example, if the number of sensed touch points is 3 in image data, the data storage unit 111 can store that the to-be-skipped object is a folder. For example, if the number of sensed touch points is 2 in music data, the data storage unit 111 can store that the to-be-skipped object is music data. For another example, if the number of sensed touch points is 3 in music data, the data storage unit 111 can store that the to-be-skipped object is a folder. For example, if the number of sensed touch points is 2 in book data, the data storage unit 111 can store that the to-be-skipped object is a page of the book data. For another example, if the number of sensed touch points is 3 in book data, the data storage unit 111 can store that the to-be-skipped object is the book data.

The operating system program 112 (e.g., a built-in operating system such as WINDOWS, LINUX, Darwin, RTXC, UNIX, OS X, or VxWorks) includes various software components for controlling a general system operation. For example, the control of the general system operation includes memory management and control, storage hardware (device) control and management, power control and management, etc. The operating system program 112 performs a function for facilitating communication between various hardware components (devices) and software components (programs).

The application program 113 includes a browser, an email, a message, word processing, an address book, a widget, a Digital Right Management (DRM), voice recognition, voice recording, a position determining function, a location based service, and a telephone application.

The graphic user interface program 114 includes at least one software component for providing a graphic-based user interface between the user and the electronic device 100. That is, the graphic user interface program 114 includes at least one software component for displaying user interface information in a front surface of the touch screen 130. According to the present disclosure, the graphic user interface program 114 includes an instruction for displaying an icon of a deleted application when entering an icon edit mode. For example, the graphic user interface program 114 can display first image data selected from a plurality of pieces of image data stored in the data storage unit 111. For another example, the graphic user interface program 114 can display first music data selected from a plurality of pieces of music data stored in the data storage unit 111. For another example, the graphic user interface program 114 can display first book data selected from a plurality of pieces of book data stored in the data storage unit 111.

In addition, the graphic user interface program 114 includes an instruction for displaying data according to a direction of moving a sensed touch. For example, if a touch sensed for image data moves in a first direction, the graphic user interface program 114 can display previous image data with respect to currently displayed image data. For another example, if a touch sensed for image data moves in a second direction, the graphic user interface program 114 can display next image data with respect to currently displayed image data. For example, if a touch sensed for music data moves in a first direction, the graphic user interface program 114 can display previous music data with respect to currently displayed music data. For another example, if a touch sensed for music data moves in a second direction, the graphic user interface program 114 can display next music data with respect to currently displayed music data. For example, if a touch sensed for book data moves in a first direction, the graphic user interface program 114 can display previous book data with respect to currently displayed book data. For another example, if a touch sensed for book data moves in a second direction, the graphic user interface program 114 can display next book data with respect to currently displayed book data.

In addition, when a touch is sensed for currently displayed data, the graphic user interface program 114 displays a graphic effect capable of simply scrolling a list including the currently displayed data, and thus a location of data to be skipped can be more easily provided to a user of the electronic device 100.

The multi-touch sensitive program 115 senses a touch for displayed data. In this case, the sensed touch can be a multi-touch in which the number of touch points is greater than or equal to 2. For example, the multi-touch sensitive program 115 can sense one touch for displayed image data. For another example, the multi-touch sensitive program 115 can sense two touches for displayed music data. For another example, the multi-touch sensitive program 115 can sense three touches for displayed book data.

In addition, the multi-touch sensitive program 115 can sense that the sensed touch moves in any direction. For example, the multi-touch sensitive program 115 can sense one touch for displayed image data, and can sense that the sensed one touch moves from right to left. For another example, the multi-touch sensitive program 115 can sense two touches for displayed music data, and can sense that the sensed two touches move from left to right. For another example, the multi-touch sensitive program 115 can sense three touches for displayed book data, and can sense that the sensed three touches move from up to down.

The list control program 116 displays data selected from a plurality of pieces of data consisting of at least one list. For example, if first image data is selected from a first image list including 50 pieces of image data, the list control program 116 can display the selected first image data. For another example, if first image data is selected from a first music list including 60 pieces of music data, the list control program 116 can display the selected first music data. For another example, if first book data is selected from a first book list including 70 pieces of book data, the list control program 116 can display the selected first book data.

In addition, if at least two touches are sensed for displayed data, the list control program 116 can determine the number of pieces of previous data or the number of pieces of next data with respect to currently displayed data according to a touch moving direction and the number of touch points. More specifically, the list control program 116 can determine the number of pieces of to-be-skipped data without having to display on the touch screen 130 on the basis of the number of touch points sensed by the multi-touch sensitive program 115, and can determine a data skip direction (or search direction) according to the touch moving direction. For example, if two touches are sensed for displayed image data, the list control program 116 can determine that the number of pieces of data to be skipped without having to display on the touch screen 130 is 10, and as the sensed two touches move from right to left, can skip 10 pieces of image data located after the currently displayed image data and thus can display image data located next thereto. For another example, if three touches are sensed for displayed image data, the list control program 116 can determine that the number of pieces of data to be skipped without having to display on the touch screen 130 is 20, and as the sensed three touches move from left to right, can skip 20 pieces of image data located before the currently displayed image data and thus can display image data located before the skipped pieces of image data. For another example, if two touches are sensed for displayed music data, the list control program 116 can determine that the number of pieces of data to be skipped without having to display on the touch screen 130 is 20, and as the sensed two touches move from right to left, can skip 20 pieces of music data located after the currently displayed music data and thus can display music data located next thereto. For another example, if three touches are sensed for displayed music data, the list control program 116 can determine that the number of pieces of data to be skipped without having to display on the touch screen 130 is 30, and as the sensed three touches move from left to right, can skip 30 pieces of music data located before the currently displayed music data and thus can display music data located before the skipped pieces of music data. If the displayed data is book data, the list control program 116 can determine the number of pages of book data to be skipped without having to display on the touch screen 130 on the number of the number of touch points, and can determine a page skip direction according to a touch moving direction. For example, if two touches are sensed for displayed book data, the list control program 116 can determine that the number of pages to be skipped without having to display on the touch screen 130 is 30, and as the sensed two touches move from right to left, can skip 30 pages located after the currently displayed page and thus can display a page located next thereto. For another example, if three touches are sensed for displayed book data, the list control program 116 can determine that the number of pages to be skipped without having to display on the touch screen 130 is 40, and as the sensed three touches move from left to right, can skip 40 pages located before the currently displayed page and thus can display a page located before the skipped pages. In this case, the number of pieces of data to be skipped can be pre-set in a design stage according to the number of touch points or can be changed by a user control.

In addition, if at least two touches are sensed for multiple pieces of data constituting at least one list, the list control program 116 can determine an object to be skipped, the number of skips, and a skip direction on the basis of currently displayed data according to a touch moving direction and the number of touch points. More specifically, the list control program 116 can determine whether data is skipped in a unit of the currently displayed data or in a higher unit (e.g., a list, a folder, a chapter, etc.) including the currently displayed data on the basis of the number of touch points sensed by the multi-touch sensitive program 115, can determine the number of to-be-skipped objects, and thereafter can determine a skip direction according to the touch moving direction. For example, if two touches are sensed for image data, the list control program 116 can determine that the skip object is the image data and can determine that the number of pieces of image data to be skipped is 10. Thereafter, as the sensed two touches move from right to left, the list control program 116 can skip the 10 pieces of image data located after current displayed image data in a list including the currently displayed image data, and can display image data located next thereto. For another example, if three touches are sensed for image data, the list control program 116 can confirm that the object to be skipped is a higher-level folder including currently displayed image data, and can determine that the number of folders to be skipped is one. Thereafter, as the sensed three touches move from right to left, the list control program 116 can display first image data included in a folder separated forwardly by one folder from the folder including the currently displayed image data. For another example, if two touches are sensed for music data, the list control program 116 can determine that the skip object is the music data and can determine that the number of pieces of music data to be skipped is 20. Thereafter, as the sensed two touches move from right to left, the list control program 116 can skip the 20 pieces of music data located after current displayed music data in a list including the currently displayed music data, and can display music data located next thereto. For another example, if three touches are sensed for music data, the list control program 116 can confirm that the object to be skipped is a higher-level folder including currently displayed music data, and can determine that the number of folders to be skipped is one. Thereafter, as the sensed three touches move from right to left, the list control program 116 can display first music data included in a folder separated forwardly by one folder from the folder including the currently displayed music data. For another example, if two touches are sensed for book data, the list control program 116 can determine that the skip object is the book data and can determine that the number of pages to be skipped is 20. Thereafter, as the sensed two touches move from right to left, the list control program 116 can skip the 20 pages located after the currently displayed book data, and can display a page located next thereto. For another example, if three touches are sensed for book data, the list control program 116 can determine that the object to be skipped is a higher-level chapter of the currently displayed page, and can determine that the number of chapters to be skipped is one. Thereafter, as the sensed three touches move from right to left, the list control program 116 can display a chapter separated forwardly by one chapter from the currently displayed page. In this case, the skip object or the number of pieces of data to be skipped determined according to the number of touch points can be pre-set in a design stage or can be changed by a user control.

In addition, if two touches are sensed for displayed data, the list control program 116 can determine the number of pieces of previous data or the number of pieces of next data with respect to currently displayed data according to a touch moving direction and a distance between the touch points. More specifically, the list control program 116 can determine the number of pieces of to-be-skipped data without having to display on the touch screen 130 on the basis of the distance between the two touch points sensed by the multi-touch sensitive program 115, and can determine a data skip direction (or search direction) according to the touch moving direction. For example, if a distance between two touch points sensed for the displayed image data is greater than or equal to a first threshold distance and less than or equal to a second threshold distance, the list control program 116 can determine that the number of pieces of data to be skipped without having to display on the touch screen 130 is 10, and as the sensed two touches move from right to left, can skip the 10 pieces of image data located after current displayed image data in a list including the currently displayed image data, and can display image data located next thereto. For another example, if the distance between the two touch points sensed for the displayed image data is greater than or equal to the second threshold distance and less than or equal to a third threshold distance, the list control program 116 can determine that the number of pieces of data to be skipped without having to display on the touch screen 130 is 20, and as the sensed three touches move from left to right, can skip 20 pieces of image data located before the currently displayed image data and thus can display image data located before the skipped pieces of image data. For another example, if a distance between two touch points sensed for the displayed music data is greater than or equal to a first threshold distance and less than or equal to a second threshold distance, the list control program 116 can determine that the number of pieces of data to be skipped without having to display on the touch screen 130 is 20, and as the sensed two touches move from right to left, can skip 20 pieces of music data located after the currently displayed music data and thus can display music data located next thereto. For another example, if the distance between the two touch points sensed for the displayed music data is greater than or equal to the second threshold distance and less than or equal to a third threshold distance, the list control program 116 can determine that the number of pieces of data to be skipped without having to display on the touch screen 130 is 30, and as the sensed three touches move from left to right, can skip 30 pieces of music data located before the currently displayed music data and thus can display music data located before the skipped pieces of music data. If the displayed data is book data, the list control program 116 can determine the number of pages of the book data to be skipped without having to display on the touch screen 130 on the basis of a distance between touch points, and can determine a page skip direction according to a touch moving direction. For example, if the distance between the two touch points sensed for the displayed book data is greater than or equal to a first threshold and less than or equal to a second threshold, the list control program 116 can determine that the number of pages to be skipped without having to display on the touch screen 130 is 30, and as the sensed two touches move from right to left, can skip 30 pages located after the currently displayed page and thus can display a page located next thereto. For another example, if the distance between the two touch points sensed for the displayed book data is greater than or equal to the second threshold distance and less than or equal to a third threshold distance, the list control program 116 can determine that the number of pages to be skipped without having to display on the touch screen 130 is 40, and as the sensed three touches move from left to right, can skip 40 pages located before the currently displayed page and thus can display a page located before the skipped pages. In this case, the number of pieces of data to be skipped can be pre-set in a design stage according to the distance between touch points or can be changed by a user control.

In addition, if at least two touches are sensed for multiple pieces of data constituting at least one list, the list control program 116 can determine an object to be skipped, the number of skips, and a skip direction on the basis of currently displayed data according to a touch moving direction and the distance between touch points. More specifically, the list control program 116 can determine whether data is skipped in a unit of the currently displayed data or in a higher unit (e.g., a list, a folder, a chapter, etc.) including the currently displayed data on the basis of the distance between touch points sensed by the multi-touch sensitive program 115, can determine the number of to-be-skipped objects, and thereafter can determine a skip direction according to the touch moving direction. For example, if a distance between the two touch points sensed for image data is greater than or equal to a first threshold distance and less than or equal to a second threshold distance, the list control program 116 can determine that the skip object is the image data and can determine that the number of pieces of image data to be skipped is 10. Thereafter, as the sensed two touches move from right to left, the list control program 116 can skip the 10 pieces of image data located after current displayed image data in a list including the currently displayed image data, and can display image data located next thereto. For another example, if the distance between the two touch points sensed for image book data is greater than or equal to the second threshold distance and less than or equal to a third threshold distance, the list control program 116 can confirm that the object to be skipped is a higher-level folder including currently displayed image data, and can determine that the number of folders to be skipped is one. Thereafter, as the sensed three touches move from right to left, the list control program 116 can display first image data included in a folder separated forwardly by one folder from the folder including the currently displayed image data. For another example, if the distance between the two touch points sensed for music data is greater than or equal to a first threshold and less than or equal to a second threshold, the list control program 116 can determine that the skip object is the music data and can determine that the number of pieces of music data to be skipped is 20. Thereafter, as the sensed two touches move from right to left, the list control program 116 can skip the 20 pieces of music data located after current displayed music data in a list including the currently displayed music data, and can display music data located next thereto. For another example, if the distance between the two touch points sensed for music data is greater than or equal to the second threshold distance and less than or equal to a third threshold distance, the list control program 116 can confirm that the object to be skipped is a higher-level folder including currently displayed music data, and can determine that the number of folders to be skipped is one. Thereafter, as the sensed three touches move from right to left, the list control program 116 can display first music data included in a folder separated forwardly by one folder from the folder including the currently displayed music data. For another example, if the distance between the two touch points sensed for book data is greater than or equal to a first threshold and less than or equal to a second threshold, the list control program 116 can determine that the skip object is the book data and can determine that the number of pages to be skipped is 20. Thereafter, as the sensed two touches move from right to left, the list control program 116 can skip the 20 pages located after current displayed page in the currently displayed book data, and can display a page located next thereto. For another example, if the distance between the two touch points sensed for book data is greater than or equal to the second threshold distance and less than or equal to a third threshold distance, the list control program 116 can determine that the object to be skipped is a higher-level chapter of the currently displayed page, and can determine that the number of chapters to be skipped is one. Thereafter, as the sensed three touches move from right to left, the list control program 116 can display a chapter separated forwardly by one chapter from the currently displayed page. In this case, the skip object or the number of pieces of data to be skipped determined according to a distance between touch points can be pre-set in a design stage or can be changed by a user control.

Although not shown, the processor 120 can include at least one processor and a peripheral interface. In addition, the processor 120 executes a specific program (instruction set) stored in the memory 110 to perform a plurality of specific functions corresponding to the program.

The touch screen 130 is a touch-sensitive display and provides an interface for a touch input/output between the electronic device 100 and the user. The touch screen 130 is a medium for sensing a touch (or contact) by using a touch sensor (not shown), for delivering the sensed touch input to the electronic device 100, and for visually providing an output from the electronic device 100 to the user. That is, the touch screen 130 provides the user with a visual output on the basis of a text, a graphic, and a video in response to the touch input.

The touch screen 130 includes a touch sensing surface for sensing a user's touch input, and senses an input of the user touch by using a haptic contact, a tactile contact, or a combination thereof. For example, a touch sensing point of the touch screen 130 corresponds to a digit of a finger used for the contact on the touch sensing surface. In addition, the touch screen 130 senses a contact made by an external device such as a stylus pen, etc., through the touch sensing surface. The detected contact is converted to an interaction corresponding to a user interface target (e.g., a soft key) displayed on the touch screen.

The touch screen 130 can use various display techniques such as a Liquid Crystal Display (LCD), a Light Emitting Diode (LED), a Light emitting Polymer Display (LPD), an Organic Light Emitting Diode (OLED), an Active Matrix Organic Emitting Diode (AMOLED), or a Flexible LED (FLED). The touch screen 130 of the present disclosure is not limited to the touch screen which uses such display techniques. In addition, the touch screen 130 can sense a start of a contact on the touch sensing surface, a movement of the contact, or a holding or ending of the contact by using various techniques of touch detection (or sensing) such as capacitive detection, resistive detection, infrared detection, or surface acoustic wave detection. The touch screen 130 of the present disclosure can sense a touch on displayed data. Further, the touch screen can sense that the sensed touch moves in a specific direction. For example, the touch screen 130 can sense a drag which moves from right to left in the touch screen 130. Further, the touch screen 130 can sense at least two touches, and can sense that the sensed at least two touches move in a specific direction. For example, the touch screen 130 can sense two drags which move from right to left in the touch screen 130.

In addition, the touch screen 130 can display previous data or next data with respect to the currently displayed data according to the touch moving direction and the number of touch points sensed for the displayed data. In addition, the touch screen 130 can display previous data or next data with respect to the currently displayed data according to the touch moving direction and the distance between the two touch points sensed for the displayed data.

Although image data, music data, and book data are taken for example in the aforementioned description for convenience, the present disclosure is not limited thereto, and thus the same method is also applicable to scrollable list data and moving picture data. For example, if multiple touches are sensed for a contact list and the sensed multiple touches move in a specific direction, the electronic device 100 can determine the number of scrolling contacts differently according to the number of touch points or a distance between the touch points. For another example, if multiple touches are sensed for a moving picture and the sensed multiple touches move in a specific direction, the electronic device 100 can display a previous moving picture or a next moving picture with respect to a currently displayed moving picture according to the number of touch points or a distance between the touch points.

FIG. 1B is a block diagram illustrating a structure of a processor for handling a function corresponding to multiple touches according to an exemplary embodiment of the present disclosure.

Referring to FIG. 1B, a processor 120 includes a multi-touch sensitive processor 122 and a list control processor 124.

The multi-touch sensitive processor 122 senses a touch for displayed data. In this case, the sensed touch can be a multi-touch in which the number of touch points is greater than or equal to 2. For example, the multi-touch sensitive processor 122 can sense one touch for displayed image data. For another example, the multi-touch sensitive processor 122 can sense two touches for displayed music data. For another example, the multi-touch sensitive processor 122 can sense three touches for displayed book data.

In addition, the multi-touch sensitive processor 122 can sense that the sensed touch moves in any direction. For example, the multi-touch sensitive processor 122 can sense one touch for displayed image data, and can sense that the sensed one touch moves from right to left. For another example, the multi-touch sensitive processor 122 can sense two touches for displayed music data, and can sense that the sensed two touches move from left to right. For another example, the multi-touch sensitive processor 122 can sense three touches for displayed book data, and can sense that the sensed three touches move from up to down.

The list control processor 124 displays data selected from a plurality of pieces of data consisting of at least one list. For example, if first image data is selected from a first image list including 50 pieces of image data, the list control processor 124 can display the selected first image data. For another example, if first image data is selected from a first music list including 60 pieces of music data, the list control processor 124 can display the selected first music data. For another example, if first book data is selected from a first book list including 70 pieces of book data, the list control processor 124 can display the selected first book data.

In addition, if at least two touches are sensed for displayed data, the list control processor 124 can determine the number of pieces of previous data or the number of pieces of next data with respect to currently displayed data according to a touch moving direction and the number of touch points. More specifically, the list control processor 124 can determine the number of pieces of to-be-skipped data without having to display on the touch screen 130 on the basis of the number of touch points sensed by the multi-touch sensitive processor 122, and can determine a data skip direction (or search direction) according to the touch moving direction.

For example, if two touches are sensed for displayed image data, the list control processor 124 can determine that the number of pieces of data to be skipped without having to display on the touch screen 130 is 10, and as the sensed two touches move from right to left, can skip 10 pieces of image data located after the currently displayed image data and thus can display image data located next thereto.

For another example, if three touches are sensed for displayed image data, the list control processor 124 can determine that the number of pieces of data to be skipped without having to display on the touch screen 130 is 20, and as the sensed three touches move from left to right, can skip 20 pieces of image data located before the currently displayed image data and thus can display image data located before the skipped pieces of image data.

For yet another example, if two touches are sensed for displayed music data, the list control processor 124 can determine that the number of pieces of data to be skipped without having to display on the touch screen 130 is 20, and as the sensed two touches move from right to left, can skip 20 pieces of music data located after the currently displayed music data and thus can display music data located next thereto.

For yet another example, if three touches are sensed for displayed music data, the list control processor 124 can determine that the number of pieces of data to be skipped without having to display on the touch screen 130 is 30, and as the sensed three touches move from left to right, can skip 30 pieces of music data located before the currently displayed music data and thus can display music data located before the skipped pieces of music data. If the displayed data is book data, the list control processor 124 can determine the number of pages of book data to be skipped without having to display on the touch screen 130 on the number of the number of touch points, and can determine a page skip direction according to a touch moving direction.

For yet another example, if two touches are sensed for displayed book data, the list control processor 124 can determine that the number of pages to be skipped without having to display on the touch screen 130 is 30, and as the sensed two touches move from right to left, can skip 30 pages located after the currently displayed page and thus can display a page located next thereto.

For yet another example, if three touches are sensed for displayed book data, the list control processor 124 can determine that the number of pages to be skipped without having to display on the touch screen 130 is 40, and as the sensed three touches move from left to right, can skip 40 pages located before the currently displayed page and thus can display a page located before the skipped pages. In this case, the number of pieces of data to be skipped can be pre-set in a design stage according to the number of touch points or can be changed by a user control.

In addition, if at least two touches are sensed for multiple pieces of data constituting at least one list, the list control processor 124 can determine an object to be skipped, the number of skips, and a skip direction on the basis of currently displayed data according to a touch moving direction and the number of touch points. More specifically, the list control processor 124 can determine whether data is skipped in a unit of the currently displayed data or in a higher unit (e.g., a list, a folder, a chapter, etc.) including the currently displayed data on the basis of the number of touch points sensed by the multi-touch sensitive processor 122, can determine the number of to-be-skipped objects, and thereafter can determine a skip direction according to the touch moving direction.

For example, if two touches are sensed for image data, the list control processor 124 can determine that the skip object is the image data and can determine that the number of pieces of image data to be skipped is 10. Thereafter, as the sensed two touches move from right to left, the list control processor 124 can skip the 10 pieces of image data located after current displayed image data in a list including the currently displayed image data, and can display image data located next thereto.

For another example, if three touches are sensed for image data, the list control processor 124 can confirm that the object to be skipped is a higher-level folder including currently displayed image data, and can determine that the number of folders to be skipped is one. Thereafter, as the sensed three touches move from right to left, the list control processor 124 can display first image data included in a folder separated forwardly by one folder from the folder including the currently displayed image data.

For yet another example, if two touches are sensed for music data, the list control processor 124 can determine that the skip object is the music data and can determine that the number of pieces of music data to be skipped is 20. Thereafter, as the sensed two touches move from right to left, the list control processor 124 can skip the 20 pieces of music data located after current displayed music data in a list including the currently displayed music data, and can display music data located next thereto.

For yet another example, if three touches are sensed for music data, the list control processor 124 can confirm that the object to be skipped is a higher-level folder including currently displayed music data, and can determine that the number of folders to be skipped is one. Thereafter, as the sensed three touches move from right to left, the list control processor 124 can display first music data included in a folder separated forwardly by one folder from the folder including the currently displayed music data.

For yet another example, if two touches are sensed for book data, the list control processor 124 can determine that the skip object is the book data and can determine that the number of pages to be skipped is 20. Thereafter, as the sensed two touches move from right to left, the list control processor 124 can skip the 20 pages located after the current displayed page, and can display a page located next thereto.

For yet another example, if three touches are sensed for book data, the list control processor 124 can determine that the object to be skipped is a higher-level chapter of the currently displayed page, and can determine that the number of chapters to be skipped is one. Thereafter, as the sensed three touches move from right to left, the list control program 116 can display a chapter separated forwardly by one chapter from the currently displayed page. In this case, the skip object or the number of pieces of data to be skipped determined according to the number of touch points can be pre-set in a design stage or can be changed by a user control.

In addition, if two touches are sensed for displayed data, the list control processor 124 can determine the number of pieces of previous data or the number of pieces of next data with respect to currently displayed data according to a touch moving direction and a distance between the touch points. More specifically, the list control processor 124 can determine the number of pieces of to-be-skipped data without having to display on the touch screen 130 on the basis of the distance between the two touch points sensed by the multi-touch sensitive processor 122, and can determine a data skip direction (or search direction) according to the touch moving direction.

For example, if a distance between two touch points sensed for the displayed image data is greater than or equal to a first threshold distance and less than or equal to a second threshold distance, the list control processor 124 can determine that the number of pieces of data to be skipped without having to display on the touch screen 130 is 10, and as the sensed two touches move from right to left, can skip the 10 pieces of image data located after current displayed image data in a list including the currently displayed image data, and can display image data located next thereto.

For another example, if the distance between the two touch points sensed for the displayed image data is greater than or equal to the second threshold distance and less than or equal to a third threshold distance, the list control processor 124 can determine that the number of pieces of data to be skipped without having to display on the touch screen 130 is 20, and as the sensed three touches move from left to right, can skip 20 pieces of image data located before the currently displayed image data and thus can display image data located before the skipped pieces of image data.

For yet another example, if a distance between two touch points sensed for the displayed music data is greater than or equal to a first threshold distance and less than or equal to a second threshold distance, the list control processor 124 can determine that the number of pieces of data to be skipped without having to display on the touch screen 130 is 20, and as the sensed two touches move from right to left, can skip 20 pieces of music data located after the currently displayed music data and thus can display music data located next thereto.

For yet another example, if the distance between the two touch points sensed for the displayed music data is greater than or equal to the second threshold distance and less than or equal to a third threshold distance, the list control processor 124 can determine that the number of pieces of data to be skipped without having to display on the touch screen 130 is 30, and as the sensed three touches move from left to right, can skip 30 pieces of music data located before the currently displayed music data and thus can display music data located before the skipped pieces of music data. If the displayed data is book data, the list control processor 124 can determine the number of pages of the book data to be skipped without having to display on the touch screen 130 on the basis of a distance between touch points, and can determine a page skip direction according to a touch moving direction.

For example, if the distance between the two touch points sensed for the displayed book data is greater than or equal to a first threshold and less than or equal to a second threshold, the list control processor 124 can determine that the number of pages to be skipped without having to display on the touch screen 130 is 30, and as the sensed two touches move from right to left, can skip 30 pages located after the currently displayed page and thus can display a page located next thereto.

For another example, if the distance between the two touch points sensed for the displayed book data is greater than or equal to the second threshold distance and less than or equal to a third threshold distance, the list control processor 124 can determine that the number of pages to be skipped without having to display on the touch screen 130 is 40, and as the sensed three touches move from left to right, can skip 40 pages located before the currently displayed page and thus can display a page located before the skipped pages. In this case, the number of pieces of data to be skipped can be pre-set in a design stage according to the distance between touch points or can be changed by a user control.

In addition, if at least two touches are sensed for multiple pieces of data constituting at least one list, the list control processor 124 can determine an object to be skipped, the number of skips, and a skip direction on the basis of currently displayed data according to a touch moving direction and the distance between touch points. More specifically, the list control processor 124 can determine whether data is skipped in a unit of the currently displayed data or in a higher unit (e.g., a list, a folder, a chapter, etc.) including the currently displayed data on the basis of the distance between touch points sensed by the multi-touch sensitive processor 122, can determine the number of to-be-skipped objects, and thereafter can determine a skip direction according to the touch moving direction.

For example, if a distance between the two touch points sensed for image data is greater than or equal to a first threshold distance and less than or equal to a second threshold distance, the list control processor 124 can determine that the skip object is the image data and can determine that the number of pieces of image data to be skipped is 10. Thereafter, as the sensed two touches move from right to left, the list control processor 124 can skip the 10 pieces of image data located after current displayed image data in a list including the currently displayed image data, and can display image data located next thereto.

For another example, if the distance between the two touch points sensed for image book data is greater than or equal to the second threshold distance and less than or equal to a third threshold distance, the list control processor 124 can confirm that the object to be skipped is a higher-level folder including currently displayed image data, and can determine that the number of folders to be skipped is one. Thereafter, as the sensed three touches move from right to left, the list control processor 124 can display first image data included in a folder separated forwardly by one folder from the folder including the currently displayed image data.

For yet another example, if the distance between the two touch points sensed for music data is greater than or equal to a first threshold and less than or equal to a second threshold, the list control processor 124 can determine that the skip object is the music data and can determine that the number of pieces of music data to be skipped is 20. Thereafter, as the sensed two touches move from right to left, the list control processor 124 can skip the 20 pieces of music data located after current displayed music data in a list including the currently displayed music data, and can display music data located next thereto. For another example, if the distance between the two touch points sensed for music data is greater than or equal to the second threshold distance and less than or equal to a third threshold distance, the list control processor 124 can confirm that the object to be skipped is a higher-level folder including currently displayed music data, and can determine that the number of folders to be skipped is one. Thereafter, as the sensed three touches move from right to left, the list control processor 124 can display first music data included in a folder separated forwardly by one folder from the folder including the currently displayed music data.

For yet another example, if the distance between the two touch points sensed for book data is greater than or equal to a first threshold and less than or equal to a second threshold, the list control processor 124 can determine that the skip object is the book data and can determine that the number of pages to be skipped is 20. Thereafter, as the sensed two touches move from right to left, the list control processor 124 can skip the 20 pages located after the currently displayed page, and can display a page located next thereto.

For yet another example, if the distance between the two touch points sensed for book data is greater than or equal to the second threshold distance and less than or equal to a third threshold distance, the list control processor 124 can determine that the object to be skipped is a higher-level chapter of the currently displayed page, and can determine that the number of chapters to be skipped is one. Thereafter, as the sensed three touches move from right to left, the list control program 116 can display a chapter separated forwardly by one chapter from the currently displayed page. In this case, the skip object or the number of pieces of data to be skipped determined according to a distance between touch points can be pre-set in a design stage or can be changed by a user control.

FIG. 2A illustrates a process of handling a function corresponding to the number of touch points of multiple touches in the electronic device 100 according to an exemplary embodiment of the present disclosure.

Referring to FIG. 2A, the electronic device 100 displays data selected from a plurality of pieces of data constituting at least one list in step 201. For example, the electronic device 100 can display first image data selected from a plurality of pieces of image data constituting a first folder. For another example, the electronic device 100 can display first music data selected from a plurality of pieces of music data constituting a second folder. For another example, the electronic device 100 can display first book data selected from a plurality of pieces of book data constituting a third folder.

In step 203, the electronic device senses multiple touches on the displayed data. In this case, if two or more touches are simultaneously sensed or a second touch is sensed within a threshold time in a state where the first touch is maintained, the electronic device 100 can recognize the touches as the multiple touches.

In step 205, the electronic device 100 determines data to be displayed on the basis of the touch points and a direction of moving the multiple touches sensed among pieces of data constituting at least one list. In other words, the electronic device 100 can confirm the number of touch points of the sensed touches, determine a skip object and the number of skips according to the number of touch points, and determine whether to display previous data or next data with respect to the currently displayed data according to a touch moving direction. In addition, the electronic device 100 can determine the skip object and the number of skips according to a distance between two touch points among the touch points of the sensed touches, and determine whether to display previous data or next data with respect to the currently displayed data according to the touch moving direction.

In step 207, the electronic device 100 can display data by switching from the selected data to the determined data.

FIG. 2B illustrates a means for handling a function corresponding to the number of touch points of multiple touches in the electronic device 100 according to an exemplary embodiment of the present disclosure.

Referring to FIG. 2B, the electronic device 100 includes a means 211 for displaying data selected from a plurality of pieces of data constituting at least one list and a means 213 for sensing multiple touches on the displayed data. In this case, the electronic device 100 performs input and output operations simultaneously, and includes a touch sensitive touch screen 130.

In addition, the electronic device 100 includes a means 215 for determining data to be displayed among a plurality of pieces of data constituting at least one list on the basis of a direction of moving the sensed multiple touches and the number of touch points. In this case, the electronic device 100 can include a means for confirming the number of sensed touches and/or a means for confirming a distance between the sensed touches.

In addition, the electronic device 100 includes a means 217 for displaying data by switching from the selected data to the determined data.

FIG. 3 illustrates a process of handling a function corresponding to a direction of moving multiple touches and the number of touch points in the electronic device 100 according to an exemplary embodiment of the present disclosure.

Referring to FIG. 3, the electronic device 100 displays a plurality of pieces of data constituting at least one list in step 301. For example, the electronic device 100 can display a plurality of pieces of image data constituting a first folder. For another example, the electronic device 100 can display a plurality of pieces of music data constituting a second folder. For another example, the electronic device 100 can display a plurality of pieces of book data constituting a third folder.

In step 303, the electronic device confirms whether data is selected. If no data is selected, returning to step 303, the electronic device 100 repeats the subsequent steps. Otherwise, if the data is selected, proceeding to step 305, the electronic device 100 displays the selected data. For example, the electronic device 100 can display first image data selected from a plurality of pieces of image data constituting the first folder. For another example, the electronic device 100 can display first music data selected from a plurality of pieces of music data constituting the second folder. For another example, the electronic device 100 can display first book data selected from a plurality of pieces of book data constituting the third folder.

Thereafter, the electronic device 100 senses multiple touches in step 307, and confirms the number of touch points of the sensed multiple touches in step 309. In other words, the electronic device 100 senses multiple touches for the displayed data, and confirms the number of touch points of the sensed multiple touches.

In step 311, the electronic device 100 confirms a specific direction in which the multiple touches move.

If the multiple touches move in a first direction, proceeding to step 313, the electronic device 100 can display data separated backwardly by a predetermined number according to the number of touch points. In other words, the electronic device 100 determines the number of pieces of data to be skipped according to the number of sensed touch points, and if the sensed touches move in the first direction, can display data separated backwardly by the determined number from currently displayed data.

For example, in case of the first direction, as illustrated in FIG. 4A, if two touches are sensed for an 50^{th} image and the sensed two touches move from right to left, the electronic device 100 can display a 60^{th} image separated forwardly by 10 images from the currently displayed 50^{th} image.

For another example, as illustrated in FIG. 4B, if three touches are sensed for a 50^{th} image and the sensed three touches move from right to left, the electronic device 100 can display a 70^{th} image separated forwardly by 20 images from the currently displayed 50^{th} image. For another example, as illustrated in FIG. 5A, if two touches are sensed for a 50^{th} MP3 song included in a folder C and the sensed two touches move from right to left, the electronic device 100 can display a 60^{th} MP3 song included in the folder C and separated forwardly by 10 MP3 songs from the 50^{th} MP3 song of the currently displayed folder C.

For yet another example, as illustrated in FIG. 5B, if three touches are sensed for a 50^{th} MP3 song included in a folder C and the sensed three touches move from right to left, the electronic device 100 can display a 1^{st} MP3 song of a folder D separated forwardly by one folder from the folder C including the currently displayed 50^{th} MP3 song.

For yet another example, as illustrated in FIG. 6A, if two touches are sensed for a 50^{th} page of book data and the sensed two touches move from right to left, the electronic device 100 can display a page 60 separated forwardly by 10 pages from the currently displayed page 50. For another example, as illustrated in FIG. 6B, if three touches are sensed for a page 50 of book data and the sensed three touches move from right to left, the electronic device 100 can display a chapter 3 separated forwardly by one chapter from a chapter 2 including the currently displayed page 50.

On the other hand, if the multiple touches move in a second direction, proceeding to step 315, the electronic device 100 can display data separated backwardly by a predetermined number according to the number of touch points. In other words, the electronic device 100 can determine the number of pieces of data to be skipped according to the number of sensed touch points, and if the sensed touches move in the second direction, can display data separated backwardly by the determined number from the currently displayed data. In this case, the second direction implies a direction different from the first direction.

For example, as illustrated in FIG. 4C, if two touches are sensed for an 50^{th} image and the sensed two touches move from left to right, the electronic device 100 can display a 40^{th} image separated backwardly by 10 images from the currently displayed 50^{th} image. For another example, as illustrated in FIG. 4D, if three touches are sensed for an 50^{th} image and the sensed three touches move from left to right, the electronic device 100 can display a 30^{th} image separated backwardly by 20 images from the currently displayed 50^{th} image.

For another example, as illustrated in FIG. 5C, if two touches are sensed for a 50^{th} MP3 song included in a folder C and the sensed two touches move from left to right, the electronic device 100 can display a 40^{th} MP3 song included in the folder C and separated backwardly by 10 MP3 songs from the 50^{th} MP3 song of the currently displayed folder C.

For yet another example, as illustrated in FIG. 5D, if three touches are sensed for a 50^{th} MP3 song included in a folder C and the sensed three touches move from left to right, the electronic device 100 can display a 1^{st} MP3 song of a folder B separated backwardly by one folder from the folder C including the currently displayed 50^{th} MP3 song.

For yet another example, as illustrated in FIG. 6C, if two touches are sensed for a 50^{th} page of book data and the sensed two touches move from left to right, the electronic device 100 can display a page 40 separated backwardly by 10 pages from the currently displayed page 50.

For yet another example, as illustrated in FIG. 6D, if three touches are sensed for a page 50 of book data and the sensed three touches move from left to right, the electronic device 100 can display a chapter 1 separated backwardly by one chapter from a chapter 2 including the currently displayed page 50.

FIG. 7 illustrates a process of handling a function corresponding to a direction of moving multiple touches and a distance between touch points in the electronic device 100 according to an exemplary embodiment of the present disclosure.

Referring to FIG. 7, the electronic device 100 displays a plurality of pieces of data constituting at least one list in step 701. For example, the electronic device 100 can display a plurality of pieces of image data constituting a first folder. For another example, the electronic device 100 can display a plurality of pieces of music data constituting a second folder. For another example, the electronic device 100 can display a plurality of pieces of book data constituting a third folder.

In step 703, the electronic device confirms whether data is selected. If no data is selected, returning to step 703, the electronic device 100 repeats the subsequent steps. Otherwise, if the data is selected, proceeding to step 705, the electronic device 100 displays the selected data. For example, the electronic device 100 can display first image data selected from a plurality of pieces of image data constituting the first folder. For another example, the electronic device 100 can display first music data selected from a plurality of pieces of music data constituting the second folder. For another example, the electronic device 100 can display first book data selected from a plurality of pieces of book data constituting the third folder.

Thereafter, the electronic device 100 senses multiple touches in step 707, and confirms a distance between the sensed touch points in step 709. In this case, the sensed multiple touches can be two touches. In other words, the electronic device 100 senses two touches for the displayed data, and confirms the distance between the sensed two touch points.

In step 711, the electronic device 100 confirms a specific direction in which the multiple touches move.

If the multiple touches move in a first direction, proceeding to step 713, the electronic device 100 can display data separated backwardly by a predetermined number according to the distance between the sensed touch points. In other words, the electronic device 100 determines the number of pieces of data to be skipped according to the distance between the sensed touch points, and if the sensed touches move in the first direction, can display data separated backwardly by the determined number from currently displayed data.

For example, as illustrated in FIG. 8A, in a state where a distance between two touch points sensed for a 50^{th} image is greater than or equal to a first threshold distance and less than or equal to a second threshold distance, if the two touches move from right to left, the electronic device 100 can display a 60^{th} image separated forwardly by 10 images from the currently displayed 50^{th} image.

For another example, as illustrated in FIG. 8B, in a state where the distance between the two touch points sensed for the 50^{th} image is greater than or equal to the second threshold distance and less than or equal to a third threshold distance, if the two touches move from right to left, the electronic device 100 can display a 70^{th} image separated forwardly by 20 images from the currently displayed 50^{th} image.

For yet another example, as illustrated in FIG. 9A, in a state where a distance between two touches sensed for a 50^{th} MP3 song included in a folder C is greater than or equal to a first threshold distance and less than or equal to a second threshold distance, if the two touches move from right to left, the electronic device 100 can display a 60^{th} MP3 song included in the folder C and separated forwardly by 10 MP3 songs from the 50^{th} MP3 song of the currently displayed folder C.

For yet another example, as illustrated in FIG. 9B, in a state where a distance between two touches sensed for a 50^{th} MP3 song included in a folder C is greater than or equal to the second threshold distance and less than or equal to a third threshold distance, if the two touches move from right to left, the electronic device 100 can display a 1^{st} MP3 song of a folder D separated forwardly by one folder from the folder C including the currently displayed 50^{th} MP3 song.

For yet another example, as illustrated in FIG. 10A, in a state where a distance between two touch points sensed for a 50^{th} page of book data is greater than or equal to a first threshold distance and less than or equal to a second threshold distance, if the two touches move from right to left, the electronic device 100 can display a page 60 separated forwardly by 10 pages from the currently displayed page 50.

For yet another example, as illustrated in FIG. 10B, in a state where a distance between two touch points sensed for a 50^{th} page of book data is greater than or equal to the second threshold distance and less than or equal to a third threshold distance, if the two touches move from right to left, the electronic device 100 can display a chapter 3 separated forwardly by one chapter from a chapter 2 including the currently displayed page 50.

On the other hand, if the multiple touches move in a second direction, proceeding to step 715, the electronic device 100 can display data separated forwardly by a predetermined number according to the distance between touch points. In other words, the electronic device 100 can determine the number of pieces of data to be skipped according to the distance between the sensed touch points, and if the sensed touches move in the second direction, can display data separated forwardly by the determined number from the currently displayed data. In this case, the second direction implies a direction different from the first direction.

For example, as illustrated in FIG. 8C, in a state where a distance between two touch points sensed for a 50^{th} image is greater than or equal to a first threshold distance and less than or equal to a second threshold distance, if the two touches move from left to right, the electronic device 100 can display a 40^{th} image separated backwardly by 10 images from the currently displayed 50^{th} image.

For another example, as illustrated in FIG. 8D, in a state where the distance between the two touch points sensed for the 50^{th} image is greater than or equal to the second threshold distance and less than or equal to a third threshold distance, if the two touches move from left to right, the electronic device 100 can display a 30^{th} image separated backwardly by 20 images from the currently displayed 50^{th} image.

For yet another example, as illustrated in FIG. 9C, in a state where a distance between two touches sensed for a 50^{th} MP3 song included in a folder C is greater than or equal to a first threshold distance and less than or equal to a second threshold distance, if the two touches move from left to right, the electronic device 100 can display a 40^{th} MP3 song included in the folder C and separated backwardly by 10 MP3 songs from the 50^{th} MP3 song of the currently displayed folder C.

For yet another example, as illustrated in FIG. 9D, in a state where a distance between two touches sensed for a 50^{th} MP3 song included in a folder C is greater than or equal to the second threshold distance and less than or equal to a third threshold distance, if the two touches move from left to right, the electronic device 100 can display a 1^{st} MP3 song of a folder B separated backwardly by one folder from the folder C including the currently displayed 50^{th} MP3 song.

For yet another example, as illustrated in FIG. 10C, in a state where a distance between two touch points sensed for a 50^{th} page of book data is greater than or equal to a first threshold distance and less than or equal to a second threshold distance, if the two touches move from left to right, the electronic device 100 can display a page 40 separated backwardly by 10 pages from the currently displayed page 50.

For yet another example, as illustrated in FIG. 10D, in a state where a distance between two touch points sensed for a 50^{th} page of book data is greater than or equal to the second threshold distance and less than or equal to a third threshold distance, if the two touches move from left to right, the electronic device 100 can display a chapter 1 separated backwardly by one chapter from a chapter 2 including the currently displayed page 50.

Although it is assumed that the first direction is a right direction and the second direction is a left direction in the aforementioned description for convenience, the present disclosure is not limited thereto. Thus, the first direction can be any one of right, left, up, down, and diagonal directions, and the second direction can be a direction different from the first direction.

Embodiments and all of the functional operations of the present disclosure described in this specification can be implemented in computer software, firmware, or hardware, including the structures disclosed in this specification and their structural equivalents, or in combinations of one or more of them. Further, the embodiments of the present disclosure described in this specification can be executed by one or more computer program products, i.e., an electronic device, a data processing device, etc., or can be implemented in one or more modules of computer program instructions encoded on a computer readable medium for controlling an operation of these devices.

The computer readable medium can be a machine-readable storage medium, a machine-readable storage substrate, a memory device, a composition of matter effecting a machine-readable propagated stream, or a combination of one or more of them. The term “data processing device” includes, for example, a programmable processor, a computer, or multiple processors or all apparatus, devices, and machines for processing data, including the computer. The apparatus can include, in addition to hardware, code that generates an execution environment for the computer program, e.g., code that constitutes processor firmware, a protocol stack, a database management system, an operating system, or a combination of one or more of them.

While the disclosure has been shown and described with reference to certain preferred embodiments thereof, it will be understood by those skilled in the art that various changes in form and details can be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method in an electronic device, the method comprising:
displaying data selected from a plurality of pieces of data constituting at least one list;
sensing multiple touches for the displayed data;
determining data to be displayed among the pieces of data constituting the at least one list on the basis of the number of touch points and a direction of movement of the sensed multiple touches; and
displaying data by switching from the selected data to the determined data.

2. The method of claim 1, wherein determining the data to be displayed comprises:
confirming a number of touch points of the sensed multiple touches;
determining the number of pieces of to-be-skipped data according to the number of confirmed touch points;
confirming a direction of moving the sensed multiple touches;
if the sensed multiple touches move in a first direction, determining data separated backwardly by the determined number from the displayed data as the data to be displayed; and
if the sensed multiple touches move in a second direction, determining data separated forwardly by the determined number from the displayed data as the data to be displayed.

3. The method of claim 1, wherein determining of the data to be displayed comprises:
confirming a number of touch points of the sensed multiple touches;
determining one of a unit of the displayed data and a unit of list including the displayed data on the basis of the confirmed number of touch points;
determining a number of the to-be-skipped objects on the basis of the confirmed number of touch points; and
confirming a direction of movement of the sensed multiple touches.

4. The method of claim 3, further comprising, in a case where the to-be-skipped object is determined to be the unit of the displayed data,
if the sensed multiple touches move in a first direction, determining data to be separated backwardly by the determined number from the displayed data as the data to be displayed; and
if the sensed multiple touches move in a second direction, determining data to be separated forwardly by the determined number from the displayed data as the data to be displayed.

5. The method of claim 3, further comprising, in a case where the to-be-skipped object is determined to be the unit of list including the displayed data,
if the sensed multiple touches move in a first direction, determining data to be included in a list separated backwardly by the determined number from the list including the displayed data as the data to be displayed; and
if the sensed multiple touches move in a second direction, determining data to be included in a list separated forwardly by the determined number from the list including the displayed data as the data to be displayed.

6. The method of claim 1, wherein determining the data to be displayed comprises:
confirming a distance between two touch points among touch points of the sensed multiple touches;
determining a number of pieces of to-be-skipped data according to the confirmed distance;
confirming a direction of moving the sensed multiple touches;
if the sensed multiple touches move in a first direction, determining data to be separated backwardly by the determined number from the displayed data as the data to be displayed; and
if the sensed multiple touches move in a second direction, determining data to be separated forwardly by the determined number from the displayed data as the data to be displayed.

7. The method of claim 1, wherein determining the data to be displayed comprises:
confirming a distance between two touch points among touch points of the sensed multiple touches;
determining one of a unit of the displayed data and a unit of list including the displayed data on the basis of the confirmed distance;
determining a number of the to-be-skipped objects on the basis of the confirmed distance; and
confirming a direction of movement of the sensed multiple touches.

8. The method of claim 7, further comprising, in a case where the to-be-skipped object is determined to the unit of the displayed data,
if the sensed multiple touches move in a first direction, determining data to be separated backwardly by the determined number from the displayed data as the data to be displayed; and
if the sensed multiple touches move in a second direction, determining data to be separated forwardly by the determined number from the displayed data as the data to be displayed.

9. The method of claim 7, further comprising, in a case where the to-be-skipped object is determined to the unit of list including the displayed data,
if the sensed multiple touches move in a first direction, determining data to be included in a list separated backwardly by the determined number from the list including the displayed data as the data to be displayed; and
if the sensed multiple touches move in a second direction, determining data to be included in a list separated forwardly by the determined number from the list including the displayed data as the data to be displayed.

10. The method of claim 1, wherein the data is at least one of image data, music data, contact data, moving picture data, and book data.

11. An electronic device comprising:
one or more processors;
a touch sensitive display;
a memory; and
one or more programs stored in the memory and configured to be executed by the one or more processors,
wherein the one or more programs include instructions for displaying data selected from a plurality of pieces of data constituting at least one list, for sensing multiple touches for the displayed data, for determining data to be displayed among the pieces of data constituting the at least one list on the basis of a number of touch points and a direction of movement of the sensed multiple touches, and for displaying data by switching from the selected data to the determined data.

12. The electronic device of claim 11, wherein the one or more programs include instructions for confirming the number of touch points of the sensed multiple touches, for determining a number of pieces of to-be-skipped data according to a number of confirmed touch points, for confirming a direction of movement of the sensed multiple touches, if the sensed multiple touches move in a first direction, for determining data to be separated backwardly by the determined number from the displayed data as the data to be displayed, and if the sensed multiple touches move in a second direction, for determining data to be separated forwardly by the determined number from the displayed data as the data to be displayed.

13. The electronic device of claim 11, wherein the one or more program include instructions for confirming the number of touch points of the sensed multiple touches, for determining one of a unit of the displayed data and a unit of list including the displayed data on the basis of the confirmed number of touch points, for determining a number of the to-be-skipped objects on the basis of the confirmed number of touch points, and for confirming a direction of moving the sensed multiple touches.

14. The electronic device of claim 13, wherein the one or more program include instructions for, in a case where the to-be-skipped object is determined to the unit of the displayed data, if the sensed multiple touches move in a first direction, determining data to be separated backwardly by the determined number from the displayed data as the data to be displayed, and if the sensed multiple touches move in a second direction, for determining data to be separated forwardly by the determined number from the displayed data as the data to be displayed.

15. The electronic device of claim 13, wherein the one or more program include instructions for, in a case where the to-be-skipped object is determined to the unit of list including the displayed data, if the sensed multiple touches move in a first direction, determining data to be included in a list separated backwardly by the determined number from the list including the displayed data as the data to be displayed, and if the sensed multiple touches move in a second direction, for determining data to be included in a list separated forwardly by the determined number from the list including the displayed data as the data to be displayed.

16. The electronic device of claim 11, wherein the one or more program include instructions for confirming a distance between two touch points among touch points of the sensed multiple touches, for determining a number of pieces of to-be-skipped data according to the confirmed distance, for confirming a direction of moving the sensed multiple touches, if the sensed multiple touches move in a first direction, for determining data to be separated backwardly by the determined number from the displayed data as the data to be displayed, and if the sensed multiple touches move in a second direction, for determining data to be separated forwardly by the determined number from the displayed data as the data to be displayed.

17. The electronic device of claim 11, wherein the one or more program include instructions for confirming a distance between two touch points among touch points of the sensed multiple touches, for determining one of a unit of the displayed data and a unit of list including the displayed data on the basis of the confirmed distance, for determining a number of the to-be-skipped objects on the basis of the confirmed distance, and for confirming a direction of movement of the sensed multiple touches.

18. The electronic device of claim 17, wherein the one or more program include instructions for, in a case where the to-be-skipped object is determined to the unit of the displayed data, if the sensed multiple touches move in a first direction, for determining data to be separated backwardly by the determined number from the displayed data as the data to be displayed, and if the sensed multiple touches move in a second direction, for determining data to be separated forwardly by the determined number from the displayed data as the data to be displayed.

19. The electronic device of claim 17, wherein the one or more program include instructions for, in a case where the to-be-skipped object is determined to the unit of list including the displayed data, if the sensed multiple touches move in a first direction, for determining data included in a list separated backwardly by the determined number from the list including the displayed data as the data to be displayed, and if the sensed multiple touches move in a second direction, for determining data to be included in a list separated forwardly by the determined number from the list including the displayed data as the data to be displayed.

20. The electronic device of claim 11, wherein the data is at least one of image data, music data, contact data, moving picture data, and book data.
